(19) United States
(12) Patent Application Publication
(10) Pub. No.: US 2009/0231178 A1
(43) Pub. Date: Sep. 17, 2009

(54) Downloadable remote control

(75) Inventors: Patrice Letourneur, Paris (FR); Avidan Lamdan, Tsur Hadassah (IL)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: NDS Limited, Middlesex (GB)

(21) Appl. No.: 11/887,057

(22) PCT Filed: Jun. 16, 2005
(86) PCT No.: PCT/IL05/00641

§ 371 Date: Nov. 23, 2007

(51) Int. Cl. G08C 19/12

(52) U.S. Cl. 341/176

(57) ABSTRACT

A universal remote control (100) is described, the universal remote control (100) including a configuration port (155) operative to receive a download of configuration information sent to a device (110), the configuration information defining a communication protocol for sending control information from the universal remote control (100) to the device (110), and a processor (148) operative to determine if the configuration has previously been downloaded to the universal remote control (100) and in response to a negative result of the determining configuration request a download of the configuration information from the device (110) to the universal remote control (100), and configure the universal remote control (100) in accordance with the received configuration information thereby configuring the universal remote control (100) to send control information to the device (110). Related methods and apparatus are also described.

### FIELD OF THE INVENTION

The present invention relates to remote control devices and more particularly to downloadable configurable remote control devices.

### BACKGROUND OF THE INVENTION

U.S. Pat. No. 4,703,359 to Rumbolt et al. describes a remote control unit which responds to activation of an “identify” button by transmitting a sequence of command signals, each of the same command in a different format. Since the appliance to be controlled is turned on, it responds in a predetermined way (e.g. a channel change) when it receives the properly formatted command. The user later terminates the learn mode and a pointer denoting the address of the last transmitted command, i.e. the properly formatted command, is stored in the unit and used as part of the address for reading data for subsequent user-selected commands out of memory.

U.S. Pat. No. 5,872,562 to McConnell et al. describes a universal remote control transmitter with simplified device identification wherein a permanent non-erasable memory stores formatting data and command bit patterns for a plurality of devices of different categories manufactured by different manufacturers to be controlled by the remote control transmitter incorporating the memory. To select the correct format, the user activates an enter initiate key, thereafter a key to indicate the category of the selected device, and thereafter two digits which together signify the manufacturer and model number. The keyboard output signals resulting from activation of the keys are stored in RAM in the microprocessor controlling the remote control transmitter's operation. The stored values in RAM constitute an address for the memory. Under microprocessor control, the data read out from memory is then applied to the transmitter driver circuit to cause the properly formatted device control signal to be transmitted.

U.S. Pat. No. 6,130,625 to Harvey describes a remote control for consolidating several native remote controls of consumer electronic devices. The remote control identifies, stores and re-transmits signals of the other remote controls for operating several of the electronic devices with one remote control unit. The remote control includes a receiver, a microprocessor, memory, and a transmitter. The remote control identifies a Protocol or transmission technique of each native remote control by comparing a transmitted signal from the native remote control to a preprogrammed data base of Protocols of the universal remote control. During the identification process, frequency and cycle count are detected to determine a Protocol carrier family. Pause and bit modulation information of the transmitted signal are detected for further refining the selection of the Protocol from the preprogrammed data base of Protocols. Finally, a second signal is examined to male the final selection of the correct Protocol. By knowing the bit modulation technique or how the bit is being sent, the universal remote control detects the code pattern of the transmitted signal and stores the code pattern and identified Protocol for later re-transmission to remotely control the electronic device.

U.S. Pat. No. 6,157,319 to Johns et al. describes a universal remote control system with device activated set up wherein the device to be controlled such as a TV, VCR or other consumer electronic product, and the associated remote control unit are pre-programmed and adapted to automatically reconfigure the remote control unit to communicate with a device to be controlled as soon as said device is connected to its power source.

U.S. Pat. No. 6,236,350 to Andrews describes a remote control apparatus and a method for identifying a reference code stored in a remote control apparatus. The remote control apparatus stores a reference code associated with a particular electronic device to be controlled and allows the user to determine the stored reference code by entering a code identification mode. In the code identification mode, the user selects a sequence of keys on the keypad and observes an indicator, such as an LED, after each key selection. The indicator is activated by a control unit when the number selected corresponds to the first digit in the reference code. The user then selects another sequence of keys on the keypad and observes the indicator after each key selection to identify the next digit in the reference code. The user repeats these steps to sequentially identify all of the digits in the reference code.

U.S. Pat. No. 6,747,568 to Teskey describes a universal remote control and a method for programming a universal remote control to allow a user to quickly and easily identify a set of remote control signal formats that include a desired signal format and then individually test the signal formats in the identified set to identify the desired signal format. A reference code, or other identification information, associated with the desired signal format. In the code search mode of operation, the present universal remote control generates and transmits one of a plurality of sets of signal formats stored in a memory circuit (RAM, ROM) in response to the user pressing a first control key. The user repeatedly presses the first control key and observes the controlled device to identify a set of signal formats that includes the desired signal format. After the desired set of signal formats is identified, the user presses either a second or a third control key to individually transmit each signal format in the identified set of signal formats. The user repeatedly presses the second and third control keys and observes the controlled device to identify the desired signal format.

U.S. Pat. No. 6,809,779 to Chang et al. describes a system and method for allowing a viewer to easily program a remote control device with the parameters of various home entertainment components such as TVs, VCRs, DVDs, etc. A removable media is inserted into each component, with the remote control parameters or model identification of the component being downloaded to the media. The media is then removed from the component and inserted into the remote control device, which uploads the model data or control parameters so that the remote control device can be used to control the component without requiring a person to manually set or configure, for each component, the “universal” master remote.

Published European Patent Application EP 0974945 A3 of Universal Electronics, Inc. describes a universal remote control system with device activated set up wherein the device to be controlled such as a TV, VCR, or other consumer electronic product, and the associated remote control unit are preprogrammed and adapted to automatically reconfigure the remote control unit to communicate with a device to be controlled as soon as the device is connected to its power source.

European Patent EP 1049844 of Magna Auteca AG, published in the German language, describes a remote control device for controlling at least one function in access devices having several types of transmitters and one type of receiver, whereby the receiver cooperates with the access device. Each transmitter has a storage device to store a system identification word and a serial number as well as a coder to code a send signal by means of an algorithm known and using a system identification word and a serial number. A different system identification word and a different range of serial numbers are assigned to each type of transmitter. The receiver of a given type has a storage device to store the system identification words and the serial number ranges of all types of transmitters as well as a decoder to decode the send signals received using the algorithm. At least one tuning unit is provided in the receiver to tune one or more transmitters and the receiver by transmitting and storing the serial number in the receiver.

European Patent EP 1240635 of Thomson Licensing S.A. describes a remote controllable device, apparatus or appliance such as a television which is adapted to receive control signals from a universal remote control device addressed to a different appliance, i.e., when said appliance has not been selected, and informs the user that said appliance is not selected. Preferably the appliance displays information as to which other appliance has been selected, for example the TV could display on its screen the fact that it is receiving a remote control signal pertaining to a VCR by saying “VCR selected” when it receives a VCR control signal.

Published PCT application WO 02/33496 of Dmitry Vyacheslavovich describes a method of remote control comprising the preparation of an information carrier with recorded data, for example, a barcode, the data about a command system and/or about transmission protocols of remote control commands for a designated remotely controlled device.

Published PCT application WO 03/056531 of Koninklijke Phillips Electronics N.V. describes a system and method for automatically programming a universal remote control. In the system, the remote control acquires identification data from a particular device at which it is pointed. The data is processed to determine command protocols associated with the particular device. Control commands for the particular device input to the remote control by a user are formatted according to the command protocols associated with the particular device.

Smart Baton System: A Universal Remote Control System in Ubiquitous Computing Environment, by Akira Aito, et al. of the University of Tokyo, describes a universal remote control system which enables users to explicitly choose an appliance with a laser pointer, and provides users with an appropriate user interface customized for each appliance. With user authentication, the smart baton system allows an appliance to provide differentiated service to each user.

The disclosures of all references mentioned above and throughout the present specification, as well as the disclosures of all references mentioned in those references, are hereby incorporated herein by reference.

### SUMMARY OF THE INVENTION

The present invention, in preferred embodiments thereof, seeks to provide an improved universal remote control which is configurable by an associated device.

There is thus provided in accordance with a preferred embodiment of the present invention directing a universal remote control at a device, the device being operative to download configuration information to the universal remote control, the configuration information defining a communication protocol for sending control information from the universal remote control to the device, determining if the configuration has previously been downloaded to the universal remote control, in response to a negative result of the determining configuration, performing the following sending information from the device to the universal remote control, receiving the configuration information at the universal remote control, and configuring the universal remote control in accordance with the received configuration information thereby configuring the universal remote control to send control information to the device.

Further in accordance with a preferred embodiment of the present invention the configuration information includes at least a look and feel for each button included in the remote control, button properties for each button included in the remote control, a remote control protocol, and cryptography information.

Still further in accordance with a preferred embodiment of the present invention the button properties include a repetition rate.

Additionally in accordance with a preferred embodiment of the present invention the button properties include a repetition frequency.

Moreover in accordance with a preferred embodiment of the present invention the cryptography information includes encryption and decryption methods.

Further in accordance with a preferred embodiment of the present invention the cryptography information includes encryption and decryption keys.

Still further in accordance with a preferred embodiment of the present invention the method includes storing the configuration information for future retrieval.

Additionally in accordance with a preferred embodiment of the present invention the method includes reading a barcode with a barcode reader operatively associated with the universal remote control, the barcode including encoded remote control configuration information, and configuring the universal remote control in accordance with the information encoded in the barcode.

Moreover in accordance with a preferred embodiment of the present invention the method includes receiving a user input, and sending control information from the universal remote control to the device in accordance with the user input.

Further in accordance with a preferred embodiment of the present invention the universal remote control includes a touch screen and the user input is input on the touch screen.

Still further in accordance with a preferred embodiment of the present invention the receiving the configuration information includes receiving a plurality of sets of configuration information.

There is also provided in accordance with another preferred embodiment of the present invention a configuration port operative to receive a download of configuration information sent to a device, the configuration information defining a communication protocol for sending control information from the universal remote control to the device, and a processor operative to determine if the configuration has previously been downloaded to the universal remote control, and in response to a negative result of the determining configuration request a download of the configuration information from the device to the universal remote control, and configure the universal remote control in accordance with the received configuration information thereby configuring the universal remote control to send control information to the device.

Further in accordance with a preferred embodiment of the present invention the configuration information includes at least a look and feel for each button included in the remote control, button properties for each button included in the remote control, a remote control protocol, and cryptography information.

Still further in accordance with a preferred embodiment of the present invention the button properties include a repetition rate.

Additionally in accordance with a preferred embodiment of the present invention the button properties include a repetition frequency.

Moreover in accordance with a preferred embodiment of the present invention the cryptography information includes encryption and decryption methods.

Further in accordance with a preferred embodiment of the present invention the cryptography information includes encryption and decryption keys.

Still further in accordance with a preferred embodiment of the present invention the apparatus includes a storage device operative to store the configuration information for future retrieval.

Additionally in accordance with a preferred embodiment of the present invention the apparatus includes a barcode reader operatively associated with the universal remote control, the barcode reader being operative to read a barcode including encoded remote control configuration information, wherein the processor configures the universal remote control in accordance with the information encoded in the barcode.

Moreover in accordance with a preferred embodiment of the present invention the apparatus includes a user input receiver, and a port operative to send control information from the universal remote control to the device in accordance with the user input.

Further in accordance with a preferred embodiment of the present invention the user input receiver includes a touch screen.

### BRIEF DESCRIPTION OF THE DRAWINGS

The present invention will be understood and appreciated more fully from the following detailed description, taken in conjunction with the drawings in which:

FIG. 1 is a simplified block diagram illustration of a downloadable remote control and a plurality of associated devices which are operative to download a configuration to the downloadable remote control, the downloadable remote control and the devices constructed and operative in accordance with a preferred embodiment of the present invention;

FIG. 2 is a flowchart diagram of the operation of the universal remote control configuration system of one of the devices within the system of FIG. 1;

FIG. 3 is a flowchart diagram of the operation of the configuration system of the downloadable remote control of FIG. 1;

FIG. 4 is a simplified block diagram illustration of the interaction between the downloadable remote control and one of the devices of FIG. 1;

FIG. 5 is a simplified pictorial illustration of an exemplary first preferred embodiment of the downloadable remote control of FIG. 1;

FIG. 6 is a simplified pictorial illustration of an exemplary second preferred embodiment of the downloadable remote control of FIG. 1; and

FIG. 7 is a simplified flow chart illustration of a preferred method of operation of the apparatus of FIG. 1.

### DETAILED DESCRIPTION OF A PREFERRED EMBODIMENT

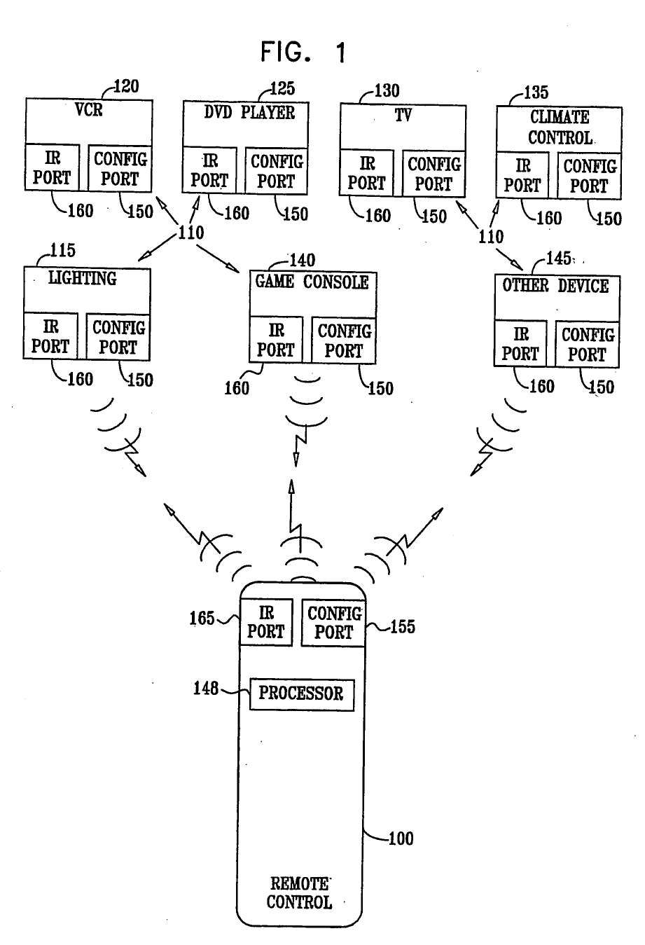

Reference is now made to FIG. 1 which is a simplified block diagram illustration of a downloadable remote control 100 and a plurality of associated devices 110 which are operative to download a configuration to the downloadable remote control 100, the downloadable remote control 100 and the devices 110 constructed and operative in accordance with a preferred embodiment of the present invention. The system of FIG. 1 comprises the remote control 100 and at least one of the devices 110. As is explained below in detail, the device 110 is capable of downloading a configuration file to the downloadable remote control 100.

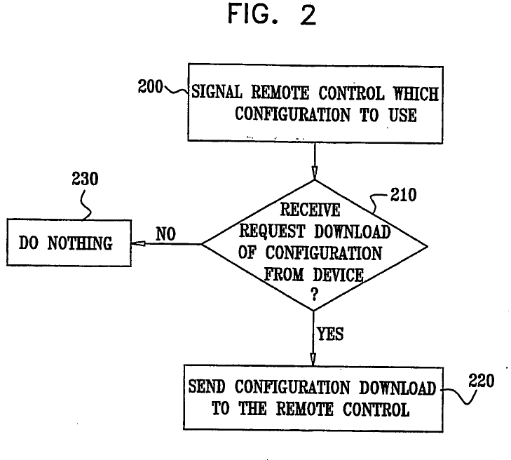

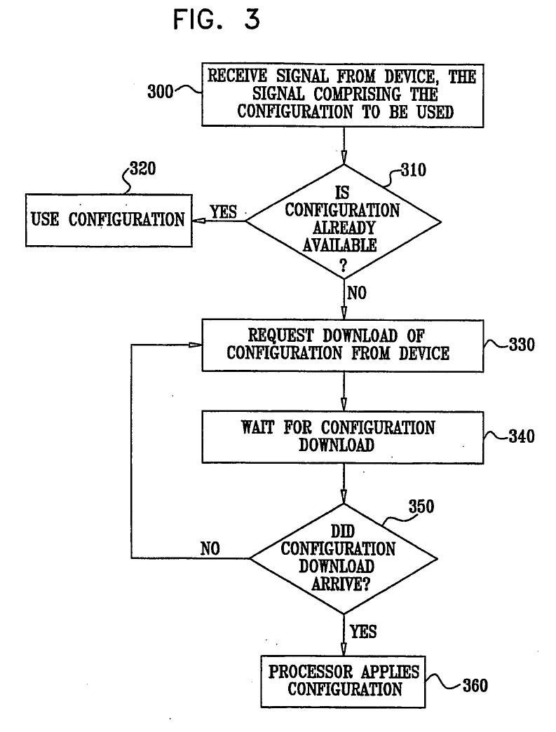

The operation of the system of FIG. 1 is now described, making additional reference to FIG. 2 and FIG. 3. FIG. 2 is a flowchart diagram of the operation of the downloadable remote control configuration system of one of the devices 110 within the system of FIG. 1. FIG. 3 is a flowchart diagram of the operation of the configuration system of the downloadable remote control 100 of FIG. 1. A plurality of devices 115, 120, 125, 130, 135, 140, 145, such as, but not limited to, lighting 115, a VCR 120, a DVD player 125, a TV 130, a climate control system 135, a game console 140, and a device generically designated as an “other device” 145, each preferably comprise downloadable remote control configuration information. The configuration information preferably comprises at least:
a look and feel for each button comprised in the remote control;
button properties, such as, but not limited to, repetition rate and repetition frequency for each button comprised in the remote control;
remote control protocol (such as, for example, RC5, RC6, or any other appropriate remote control protocol); and
cryptography information, such as, but not limited to, encryption and decryption methods and keys, preferably for use with applications rung on the associated device 110.

Optionally, help information preferably comprising at least information about button functionality may preferably also be comprised in the configuration information.

When the remote control 100 is pointed at one of the plurality of devices 115, 120, 125, 130, 135, 140, 145, the device preferably signals the remote control which configuration to use (step 200). At the remote control 100 the signal comprising an indication of which configuration to use is preferably received (step 300). The remote control 100 then preferably evaluates ifthe configuration indicated in step 200 is available (step 310). If the configuration indicated in step 200 is available, then the remote control 100 preferably uses the configuration indicated in step 200 (step 320). If the configuration indicated in step 200 is not available, the remote control 100 preferably requests a download of the configuration indicated in step 200, preferably from the one of the plurality of devices 115, 120, 125, 130, 135, 140, 145 (step 330). The remote control then preferably enters a waiting state (step 340).

When the one of the plurality of devices 115, 120, 125, 130, 135, 140, 145 receives the download request of step 330 (step 210), the one of the plurality of devices 115, 120, 125, 130, 135, 140, 145 preferably sends the configuration download to the remote control (step 220). Otherwise, the one of the plurality of devices 115, 120, 125, 130, 135, 140, 145 preferably does nothing (step 230).

The remote control 100 preferably determines if the download of the configuration indicated in step 200 has arrived (step 350). If the configuration indicated in step 200 has not arrived, after the request for the download times out, and, if the remote control 100 is still pointed at the one of the plurality of devices 115, 120, 125, 130, 135, 140, 145, the remote control. 100 again preferably requests a download of the configuration indicated in step 200 preferably from the one of the plurality of devices 115, 120, 125, 130, 135, 140, 145 (step 330). On the other hand, if the download of the configuration indicated in step 200 has arrived, a processor 148 comprised in the remote control 100 preferably applies the received configuration information to the remote control 100.

The plurality of devices 115, 120, 125, 130, 135, 140, 145 each preferably comprises a configuration port 150. Similarly, the remote control 100 also preferably comprises a configuration port 155. Configuration information and requests for configuration information, as described in steps 210 and 330 preferably flow between the device configuration port 150 and the remote control configuration port 155. The plurality of devices 115, 120, 125, 130, 135, 140, 145 each preferably also comprises an infra-red port 160. Similarly, the remote control 100 preferably also comprises a infra-red port 165. The infra-red port enables standard remote control communication between the remote control 100 and a device being controlled remotely, such as one among the plurality of devices 115, 120, 125, 130, 135, 140, 145. Those skilled in the art will appreciate that in certain preferred implementation of the present invention, the device infra-red port 160, and the device configuration port 150 are preferably the same ports. Similarly, the remote control infra-red port 165, and the remote control configuration port 155 are preferably the same ports. Alternatively, the configuration information may not be sent via infra-red signal, but may be sent by radio signals, blue tooth, or any other appropriate wireless communication technology. Throughout the present disclosure and figures, references are made to infra-red only by way of example.

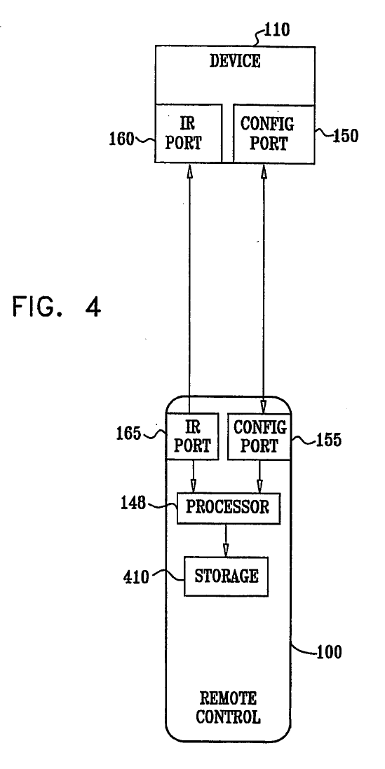

Reference is now made to FIG. 4, which is a simplified block diagram illustration of the downloadable remote control 100 and one of the devices 110 of FIG. 1. As explained above with references to FIGS. 2 and 3, if the remote control 100 does not have configuration information for the device 110, when the remote control 100 is pointed at the device 110, configuration information is preferably sent from the device configuration port 150. The configuration information is received by the remote control 100 at the configuration port 155. Configuration information is preferably sent from the configuration port 155 to the processor 148. The processor 148 preferably stores received configuration information in storage 410. In some preferred embodiments of the present invention the remote control 100 may not comprise storage.

Remote commands to the device 110 are sent from the remote control 100 when a remote control button is pressed. The processor 148, in reaction to the remote control button being pressed preferably sends, in accordance with the received configuration information, an appropriate remote control signal from the remote control 100 infra-red port 165. The device 110 preferably receives the remote control signal at the device 110 infra-red port 160. An appropriate response to the received remote control signal then preferably occurs at the device 110.

In one preferred embodiment of the present invention, older, legacy devices which do not comprise a mechanism for downloading configuration information to the remote control 100 may be equipped with a printed barcode. The barcode, preferably readable by the remote control 100, preferably comprises configuration information for the remote control.

The remote control 100 is preferably equipped with a touch screen (not depicted). The display on the touch screen is preferably controlled by the processor 148 such that the number of buttons displayed, the look and feel of the buttons, and so forth, would be entirely under the control of the processor 148, preferably in accordance with the received configuration information.

The remote control storage 410 preferably is operative to store sets of user preferences. For example, and without limiting the generality of the foregoing, a user preference may preferably comprise a time threshold for pressing a button. If the button is pressed for an amount of time exceeding the threshold, the remote control 100 preferably reacts as if the button was pressed twice.

Those skilled in the art will appreciate that the configuration information is preferably application dependent as well as device dependent. For example, and without limiting the generality of the foregoing, if the device is a game console 140 (FIG. 1), for a first game application on the game console 140, a first set of configuration information may preferably be downloaded to the remote control 100. For a second game application on the game console 140, a second, and generally different, set of configuration information may preferably be downloaded to the remote control 100. Moreover, the remote control preferably is preferably able to receive several different configurations for the same application where different users of the same application have different user preferences or profiles, resulting in different remote control 100 configurations.

It is appreciated that the functionality described above as being carried out by the processor 148 (FIG. 1) may be carried out by a suitable set of components, such as a configuration determiner, a download requester, and remote control configurator (all not shown).

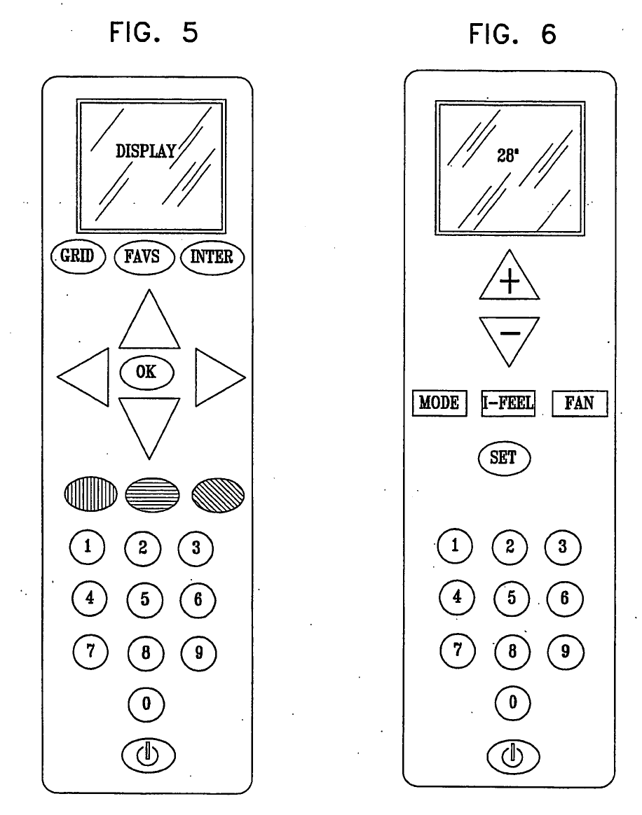

Reference is now made to FIG. 5 and FIG. 6. FIG. 5 is a simplified pictorial illustration of an exemplary first preferred embodiment of the downloadable remote control of FIG. 1. FIG. 6 is a simplified pictorial illustration of an exemplary second preferred embodiment of the downloadable remote control of FIG. 1. The preferred embodiment depicted in FIG. 5 is a downloadable remote control configured as a remote control for a typical set top box. The preferred embodiment depicted in FIG. 6 is a downloadable remote control configured as a remote control for a typical climate control unit. The configurations depicted in FIG. 5 and FIG. 6 are provided by way of example only, and are not meant to be limiting.

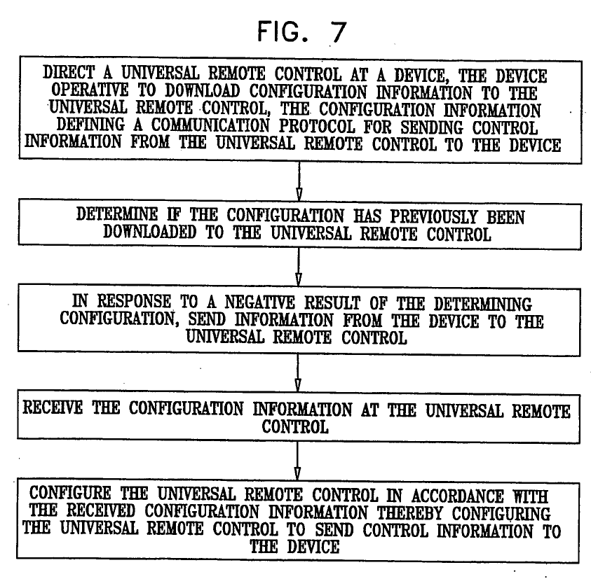

Reference is now made to FIG. 7, which is a simplified flow chart illustration of a preferred method of operation of the apparatus of FIG. 1. FIG. 7 is believed to be self explanatory in light of the above discussion.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined only by the claims which follow:

1. A method for configuring a universal remote control, the method comprising:
directing a universal remote control at a device, the device being operative to download configuration information to the universal remote control, the configuration information defining a communication protocol for sending control information from the universal remote control to the device;
determining if the configuration has previously been downloaded to the universal remote control;
in response to a negative result of the determining configuration, performing the following:
sending information from the device to the universal remote control;
receiving the configuration information at the universal remote control; and
configuring the universal remote control in accordance with the received configuration information thereby configuring the universal remote control to send control information to the device.

2. The method according to claim 1 and wherein the configuration information comprises at least:
a look and feel for each button comprised in the remote control;
button properties for each button comprised in the remote control;
a remote control protocol; and
cryptography information.

3. The method according to claim 2 and wherein the button properties comprise a repetition rate.

4. The method according to claim 2 and wherein the button properties comprise a repetition frequency.

5. The method according to claim 2 and wherein the cryptography information comprises encryption and decryption methods.

6. The method according to claim 2 and wherein the cryptography information comprises encryption and decryption keys.

7. The method according to claim 1 and also comprising storing the configuration information for future retrieval.

8. The method according to claim 1 and also comprising:
reading a barcode with a barcode reader operatively associated with the universal remote control, the barcode comprising encoded remote control configuration information; and
configuring the universal remote control in accordance with the information encoded in the barcode.

9. The method according to claim 1 and also comprising:
receiving a user input; and
sending control information from the universal remote control to the device in accordance with the user input.

10. The method according to claim 9 and wherein the universal remote control comprises a touch screen and the user input is input on the touch screen.

11. The method according to claim 1 and wherein the receiving the configuration information comprises receiving a plurality of sets of configuration information.

12. A universal remote control comprising:
a configuration port operative to receive a download of configuration information sent to a device, the configuration information defining a communication protocol for sending control information from the universal remote control to the device; and
a processor operative to:
determine if the configuration has previously been downloaded to the universal remote control; and
in response to a negative result of the determining configuration:
request a download of the configuration information from the device to the universal remote control; and
configure the universal remote control in accordance with the received configuration information thereby configuring the universal remote control to send control information to the device.

13. The apparatus according to claim 12 and wherein the configuration information comprises at least:
a look and feel for each button comprised in the remote control;
button properties for each button comprised in the remote control;
a remote control protocol; and
cryptography information.

14. The apparatus according to claim 13 and wherein the button properties comprise a repetition rate.

15. The apparatus according to claim 13 and wherein the button properties comprise a repetition frequency.

16. The apparatus according to claim 13 and wherein the cryptography information comprises encryption and decryption methods.

17. The apparatus according to claim 13 and wherein the cryptography information comprises encryption and decryption keys.

18. The apparatus according to claim 12 and also comprising a storage device operative to store the configuration information for future retrieval.

19. The apparatus according to claim 12 and also comprising a barcode reader operatively associated with the universal remote control, the barcode reader being operative to read a barcode comprising encoded remote control configuration information,
wherein the processor configures the universal remote control in accordance with the information encoded in the barcode.

20. The apparatus according to claim 12 and also comprising:
a user input receiver; and
a port operative to send control information from the universal remote control to the device in accordance with the user input.

21. The apparatus according to claim 20 wherein the user input receiver comprises a touch screen.

22. A universal remote control comprising:
configuration port means for downloading configuration information to the universal remote control, the configuration information defining a communication protocol for sending control information from the universal remote control to the device; and
processing means for:
determining if the configuration has previously been downloaded to the universal remote control; and
in response to a negative result of the determining configuration:
requesting a download of the configuration information from the device to the universal remote control; and
configuring the universal remote control in accordance with the received configuration information thereby configuring the universal remote control to send control information to the device.
